(19) United States
(12) Patent Application Publication
(10) Pub. No.: US 2011/0058943 A9
(43) Pub. Date: Mar. 10, 2011

(54) METHOD AND DEVICE FOR BRAKING THE ROTOR OF A WIND ENERGY PLANT

(75) Inventor: Gerald Hehenberger, Klagenfurt (AT)

(73) Assignee: WINDTEC GMBH, Klagenfurt (AT)

(21) Appl. No.: 11/908,570

(22) PCT Filed: Mar. 9, 2006
(86) PCT No.: PCT/AT06/00101

§ 371 Date: Jun. 18, 2009

(30) Foreign Application Priority Data
Mar. 18, 2005 (AT) A 468/2005

(51) Int. Cl. F03D 7/02

(52) U.S. Cl. 416/1; 416/169 R

(57) ABSTRACT

The invention relates to a method and device for braking the rotor of a wind energy plant, comprising rotor blades (3) mounted to rotate on the rotor with electrical devices in the rotor hub (2), such as an actuator (4, 5) for the rotation of the rotor blades (3), whereby on drop-out of the power supply to the electrical devices (4, 5), a rotor brake is activated (11), whereupon the rotor blades (3) as a result of the braking torque of the rotor brake (11) are rotated into the feathered position by means of the inertia thereof.

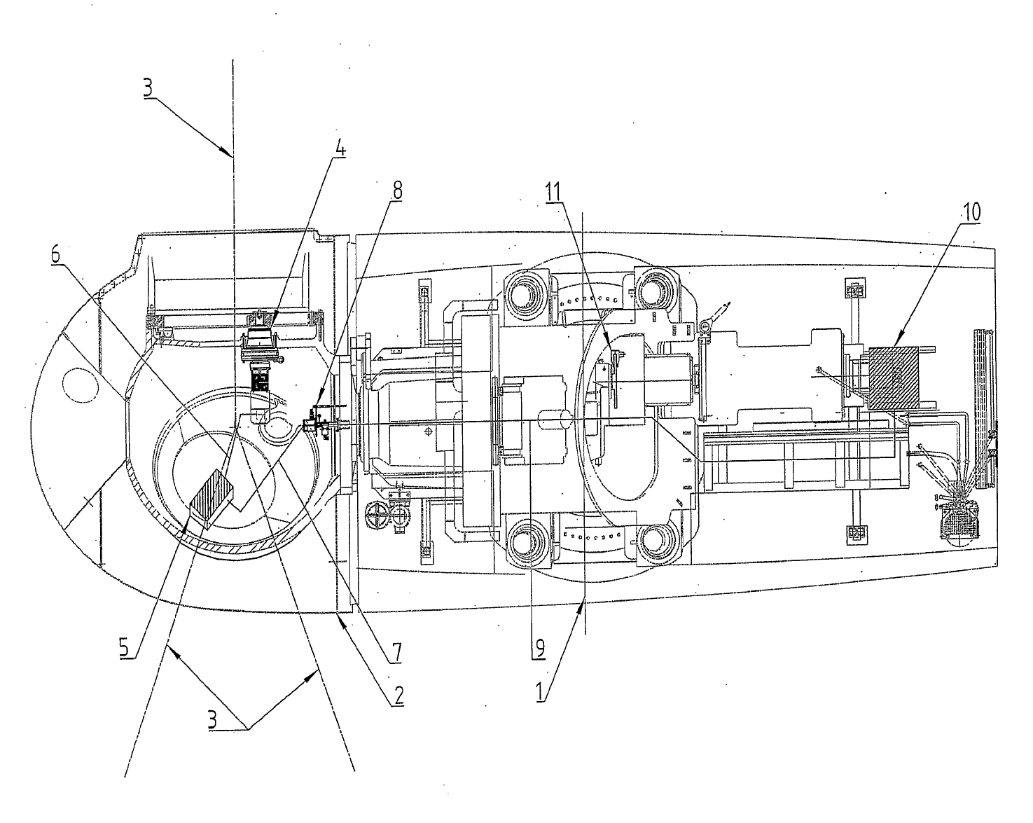

The invention concerns a fixture for rotating rotor blades mounted to rotate on a rotor hub of a wind energy plant, with electrical devices in the rotor hub such as an actuator for rotating the rotor blades, featuring a lock connected with the rotor blades, which can be activated in the event the power supply of the actuator fails or the actuator itself and which when activated prevents the rotor blades from rotating in operating mode, with a rotor brake and emergency power supply.

Furthermore, the invention concerns a method for braking a rotor belonging to a wind energy plant with rotor blades allocated on a rotor hub, with electrical devices in the rotor hub such as a actuator for rotating the rotor blades, featuring a lock connected with the rotor blades, which can be activated in the event the power supply of the actuator fails or the actuator itself and which when activated prevents the rotor blades from rotating in operating mode.

Such a fixture is known from WO 99/23384 A1. With this fixture, a lock is provided for on the rotor blade adjusting unit, which is activated in the event the power supply fails whereupon the rotor blades are only able to rotate to the feathered position and are kept in this position until the plant comes to a halt and the power supply can be restored. Although this fixture provides for secure braking of the plant in the event of a failure on the part of the power supply, it presents the disadvantage that a relatively large sweep is required for the reliable function of this fixture that is an angle from the longitudinal axis of the rotor blade and its rotational axis even if in unfavorable cases the rotor blades without a actuator, which in turn would require an emergency power supply, are to be turned into a feathered position. That is, a large sweep also incurs sizeable loads in normal operation, which requires the implementation of larger adjustment actuators for the rotor blades. This results in greater installation costs and increased power consumption and reduces the dynamics of the actuators due to greater inertia moment of the actuators. In summary, either the disadvantage of increased installation and operating costs due to a greater sweep or the necessity of batteries in the hub to support the retracting rotation of the rotor blades to the feathered position by means of the rotor blade actuators results with the fixture corresponding to WO 99/23384 A1. As such, the fundamental task of the invention comprises providing a fixtures of the type described in the introductory text, with which the braking of the rotor also functions reliably if no sweep exists or only minor sweep is present and no individual emergency power supply is provided for each actuator of each individual rotor blade.

This task is solved with the fixture with the features of claim 1.

A further fundamental task of the invention comprises providing a method for braking a rotor of a wind energy plant, with which as with the inventive fixture no or minor sweep as well as no individual emergency power supply are necessary for each actuator of each individual rotor blade.

This task is solved with a method with the features of claim 6.

The invention uses the rotor brake always inherently present in wind energy plants, which however is only used as a parking break according to the application regulations during the maintenance of the wind energy plant or as an emergency brake in the event a component of the plant fails, in conjunction with the lock for rotating the rotor blades into the feathered position. The invention demonstrates utility in that torque is applied to the rotor blades by means of using the rotor brake. This torque rotates said blades into the feathered position. At the same time, gravity and the forces of the wind are acting on the rotor blades, which support the rotation of the rotor blades into the featured position. By means of combining all these features, an exceptionally rapid and secure rotation of the rotor blades into the featured position can be effected without the requirement for considerable sweep or assistance from rotor blade actuators with a consequently necessary, redundant emergency power supply in the form of batteries. The power supply of the electrical devices allocated in the hub such as the actuators to rotate the rotor blades can exclusively occur at the rotor shaft via an electrical rotary connector such as slip rings. An emergency power supply outside of the hub, e.g. in the pod or tower of the wind energy plant, can see to the continual supply of the rotating actuator e.g. in the event of brief grid power outages, and the plant can always be deactivated in a regulated manner. However, if e.g. in the event of a failure on the part of the emergency power supply, the slip ring, any of the connecting lines or the actuator, an emergency deactivation is necessary, the braking torque of the rotor brake in conjunction with the inertia of the rotor blades ensure a rapid and reliable rotation of the rotor blades into the feathered position and as such, safe deactivation of the plant.

As a redundant emergency power supply is no longer necessary in the rotating rotor hub, rather this can be allocated outside of the hub, which emergency power supply is necessary anyhow for the control of the plant, lower plant and/or maintenance costs result in the end.

Further features and benefits of the invention result on the basis of the following description of a sample configuration of the invention with reference to the diagram attached.

In the diagram, a pod 1 of a wind energy plant, on which a pod 2 is mounted in a rotatable fashion, is rendered schematically. Rotatable rotor blades 3, schematically rendered, are mounted on the pod 2 by means of their rotational axes. An actuator consisting of a motor 4 and frequency converter 5 for each rotor blade 3 is provided for in order to rotate the rotor blades 3. Each motor 4 is equipped with a lock, which prevents the rotation of the rotor blades 3 in the operational position when activated, but permits continual or intermittent rotation of the rotor blades 3 in the feathered position. When deactivated, the lock is inactive, that is rotation of the rotor blades 3 in all directions is possible. The lock may be constructed and function as described e.g. in WO 99/23384 A1. The lock may also be configured such that it catches solely the rotor blades 3 in the feathered position and prevents them from rotating back into the operating position.

Each frequency converter 5 is connected with a motor 4 via a line 6. The power supply of the frequency converter 5 occurs via a connecting line 7, which is linked to a slip ring 8 on the rotor shaft. An emergency power supply 10 is connected to the slip ring 8 on the pod-end via an additional connecting line 9 e.g. featuring a battery and/or an accumulator. Finally, an additional rotor brake 11 is provided for, which serves to brake and park the rotor and/or the rotor hub 2.

All remaining components of the wind energy plant can be configured on the basis of the state-of-the-art as known.

The control of the plant and lock on motor 4 is configured such that the rotor brake 11 as well as the lock on actuator 4 are activated in the event of an interruption to the power supply, e.g. due to a failure on the part of the motor 4, the slip ring 8 or a break in lines 6, 7, 9 or a defect in the frequency converter 5, which makes an emergency, as rapid as possible deactivation of the plant using braking of the rotor necessary. As a result, the rotor is braked by the rotor brake 11 and at the same time, the lock prevents the rotor blades 3 from rotating into the operating position. By means of the inertia of the rotor blades 3 and the position of the center of gravity outside of its rotational axis, they are rotated by the braking moment of the rotor brake 11 into the feathered position, whereupon the forces of the wind and gravity support this rotation of the rotor blades 3 into the feathered position at least at certain intervals. In this regard, it is not necessary to provide for additional measures such as an emergency power supply of the actuators 4, 5 or sizeable sweep of the rotor blades 3 thanks to the braking moment of the rotor brake 11 since the rotor brake 11 provides sufficient torque for rapidly rotating the rotor blades 3 into the feathered position. At the same time, it is possible by means of the emergency power supply 10 in the pod 1, to supply the actuators 4 for the controlled deactivation of the plant if necessary, e.g. in the event of a disturbance to an electrical connection between the plant and the grid, which it supplies with power, with emergency power providing a functioning current/control connection exists between the plant control unit, frequency converter 5 and motor 4.

Although the rotor brake 11 can be configured as a high-performance brake, this may also be configured with the invention merely as an emergency and maintenance brake as the rotor brake 11 only has to be used in an emergency, that is in the event of a failure of the components specified and to the extent the rotor blades 3 in connection with the lock do not move into the feathered position on their own by means of the sweep and/or a center of gravity of the rotor blades 3 located outside of the rotational axis of the rotor blades 3 and when the rotor reaches a hypercritical rpm.

1. Fixture for actuating rotor blades mounted to rotate on a rotor hub of a wind energy plant, featuring electrical devices in the rotor hub such as an actuator for the rotation of the rotor blades with a lock connected with the rotor blades, which can be independently activated in the event of a failure of the power supply of the actuator or the actuator and which when activated prevents the rotor blades from rotating into the operating position, featuring a rotor brake and an emergency power supply, the emergency power supply for the electrical devices located in the rotor hub being located outside of the rotor hub and being connected with the electrical devices.

2. Fixture as per claim 1, wherein the center of gravity of rotor blades is located outside of their rotational axes.

3. Fixture according to claim 1, wherein the longitudinal axis of the rotor blades is slanted towards the rotational axis of the rotor blades.

4. Fixture as per claim 1, wherein the emergency power supply located in a pod or a shaft of the wind energy plant is a battery connected via an electrical rotary connection with the electrical devices.

5. Fixture as per claim 1, wherein the lock allows a continual or discontinuous rotational of the rotor blades into the feathered position.

6. Method for braking a rotor of a wind energy plant featuring rotor blades mounted on the rotor to rotate, with electrical devices in the rotor hub such as an actuator for the rotation of the rotor blades and with a lock connected with the rotor blades, which can be independently activated in the event of a failure of the power supply for the actuator or the actuator and which when activated prevents the rotor blades from rotating into the operating position characterized in that a rotor brake is activated in the event of a failure of the power supply for the electrical devices and that the rotor blades are rotated into the feathered position due to the braking moment of the rotor brake by means of their inertia.

7. Method as per claim 6, wherein the rotor brake is only activated with a rotor rpm exceeding a predefined critical value.

8. Method as per claim 7, wherein, in the event of a failure of the power supply of the actuator or the actuator and of a rotor rpm that overruns the predefined critical value, the rotor brake is activated and the blade rotors are rotated into the feathered position due to the braking moment of the rotor brake by means of their inertia, whereas, in the event of a failure of the power supply of the actuator or the actuator and a rotor rpm underruns the predefined critical value with an inactive rotor brake, the rotor blades are rotated into the feathered position solely with the assistance of the lock by means of the wind and/or gravitational forces acting on the rotor blades.

9. Method as per claim 6, wherein the actuators are supplied with electrical energy in the event of a failure in the electrical connection of the wind energy plant to the connected grid by means of a emergency power supply located outside of the hub.

10. Method according to claim 6, wherein the rotor blades are rotated into the feathered position in the event the lock is activated by means of torque resulting on the basis of their sweep.

11. Method as per claim 6, wherein the activated lock allows a continual or discontinuous rotation of the rotor blades into the feathered position.

12. Method as per claim 6, wherein a battery or equivalent is used as an emergency power supply.

13. Method as per claim 6, wherein supplying of the electrical devices with emergency power is effected by an emergency power supply which is located outside of the rotary hub, being connected via an electrical rotary connection to the electrical devices.

14. Method as per claim 13, wherein the emergency power supply is located in a pod or a tower of the wind energy plant.

15. Method as per claims 13, wherein the rotary connection is a slip ring.

16. Fixture as per claim 1, wherein the emergency power supply is located in a pod of the wind energy plant.

17. Fixture as per claim 1, wherein the emergency power supply is located in a shaft of a wind energy plant.

18. Fixture as per claim 1, wherein the electric rotary connection is a slip ring.
